(19) United States
(12) Patent Application Publication
(10) Pub. No.: US 2008/0138553 A1
(43) Pub. Date: Jun. 12, 2008

(54) Multi-layer tubes or conduits and manufacturing methods therefor

(76) Inventors: Eduardo Lauer, Zebulon, NC (US); Nicholas James Chwalek, Knightdale, NC (US); Francis Matthew Dum, Bartlesville, OK (US)

Correspondence Address: Melvin I. Stoltz, 51 Cherry Street, Milford, CT, 06460, US

(21) Appl. No.: 11/986,619

(22) Filed: Nov. 21, 2007

Related U.S. Application Data
(60) Provisional application No. 60/861,658, filed on Nov. 29, 2006.

(51) Int. Cl. B32B 1/08; B32B 3/26; B29D 23/00

(52) U.S. Cl. 428/36.5; 428/34.1; 264/171.29

(57) ABSTRACT

By advancing a plurality of independent layers or profiles onto a rotating mandrel, and continuously bonding the layers or profiles together, an elongated, hollow, large diameter, multi-component and/or multi-layer tube or conduit is achieved. A wide variety of various materials, forms, profiles, composites, and components can be employed to produce the desired multi-component/multi-layer tube or conduit of the present invention. In this way, the multi-component and/or multi-layer tube or conduit is constructed possessing specific physical and structural attributes particularly suited to the needs of one or more industries or technological areas. As a result, prior art expensive manufacturing methods are completely eliminated and an effective, cost-efficient, multi-component/multi-layer tube or conduit having precisely desired requirements is realized.

### RELATED APPLICATIONS

This application is related to U.S. Provisional Patent Application Ser. No. 60/861,658, filed Nov. 29, 2007 entitled MULTI-LAYER TUBES OR CONDUITS AND MANUFACTURING METHODS THEREFOR.

### TECHNICAL FIELD

This invention relates to foamed products and methods for manufacture and, more particularly, to foamed products manufactured by continuous formation in a substantially cylindrical configuration and comprising a plurality of layers and/or a plurality of components.

### BACKGROUND ART

During the last few decades, substantial effort has been expended and interest has developed in the formation and construction of products using foamed and non-foamed plastic materials. Typically, these products are formed either by extrusion or molding. However, regardless of which method is employed, production limitations exist on the size and shape in which products can be efficiently produced at competitive prices.

One example of the type of products produced using the extrusion process is the creation of hollow elongated cylindrical tubes formed from foamed thermoplastic material. These tubes are used in a wide variety of products, most typically as insulation for fluid carrying pipes or conduits.

Although the extrusion manufacturing process for forming foamed cylindrically shaped thermoplastic tubes has progressed over the years to an extremely efficient production system, tube diameters greater than about seven inches are incapable of being produced on conventional equipment. Even though a substantial market exists for large diameter tubes formed of thermoplastic material, this demand cannot be satisfied using conventional extrusion equipment. Large diameter foam tubes require manufacturers to invest in the purchase of extremely expensive manufacturing equipment, before this demand can be met using current technology.

In view of the substantial investment that must be made by manufacturing companies in obtaining equipment for satisfying the industry needs for larger diameter cylindrical tube members, the products produced to meet this demand are extremely expensive, when compared to the conventional price for smaller diameter thermoplastic tubes. However, in spite of the demand for such products and the industry desire for competitive prices, prior art technology has failed to provide a manufacturing method capable of producing large diameter cylindrical tubes in a cost effective, price competitive manner.

In addition to the industry demands for larger diameter, hollow, cylindrical tubes, substantial demand also exists for foamed thermoplastic material formed in large sheet form in a wide range of thicknesses. Generally, conventional, lower cost extrusion equipment for forming foamed thermoplastic products is incapable of producing foamed polymer sheets having widths greater than about 12″ with a thickness of about ½″. Consequently, the demand for large width foam plastic sheet is incapable of being satisfied by conventional manufacturers having lower cost extrusion equipment. In order to satisfy the industry needs for larger and thicker products, extremely expensive, custom designed equipment must be purchased, causing the large width foam sheet products produced thereby to be more costly. In addition, the return of capital for this investment is low.

Although the specialized manufacturers who own this expensive equipment are capable of producing foamed thermoplastic sheet material in large width configurations, these manufacturers are still limited in the thickness that can be produced in a single sheet, unless substantially greater investments are made for this production equipment. Typically, without expensive enhancements, prior art sheet extruders are capable of producing sheet material having a maximum thickness of about ½″.

Consequently, any customer desiring to have a final product thicker than ½″, is required to have the product produced by extremely costly manufacturing equipment or by employing a plurality of sheets which are cut to size and integrally bonded to each other in order to build up a final product to the desired thickness. As a result, additional manufacturing and handling expenses are incurred and the final product produced by these specialized procedures is substantially increased in cost.

In order to produce plank material in thicknesses greater than ½″ without expensive equipment, a plurality of sheets must be laminated or bonded together in secondary processes, increasing the thickness of the profile by ½″ with each process. Such lamination steps substantially increase the complexity of the manufacturing procedures as well as increasing the overall scrap rates.

In an attempt to enable plank material to be produced in thicknesses greater than ½″, accumulators have been constructed and used with extruders. By employing an extruder/accumulator combination, the foamed plastic is transferred directly from the extruder in the accumulators until the accumulator is filled. Then, using a piston or ram, the accumulated plastic is forced out of the accumulator. Using this system, planks with thicknesses up to 2″ can be achieved. However, this process is inefficient, since it must be run intermittently and cannot be operated continuously. Furthermore, a high scrap rate is obtained due to the intermittent stop/start process.

In attempting to resolve this prior art deficiency, Nomaco Inc. of Zebulon N.C. developed a unique system and manufacturing process for spiral forming hollow foam tubes or products having virtually any desired diameter. In addition to achieving hollow foam tubes of virtually any desired diameter and length, the same process was employed for forming large sheets or planks of thermoplastic foam material in any thickness and width desired. This unique system and manufacturing process are fully disclosed in U.S. Pat. Nos. 6,306,235 and 6,537,405.

Although the teaching contained in these patents provided a substantial advance over existing prior art technology, with an entirely new product line being produced in a highly effective and efficient process and in an extremely price competitive manner, further product areas continue to exist which had not been contemplated or addressed by the technological advances disclosed in the spiral forming process patents. As a result, product difficulties and drawbacks continue to exist in the marketplace, which have not been capable of being eliminated by these prior art achievements.

In a wide variety of commercial applications, large diameter, elongated hollow tubes or conduits formed from insulating and/or protecting materials are required for peripherally surrounding elongated lengths of pipes, conduits, refrigeration lines, tanks, domes, covers, and the like, which are used in various constructions and in numerous and diverse applications. In the ever-changing marketplace, new requirements are continuously being imposed on such insulating and/or protecting products, requiring such products to possess a wide variety of diverse physical properties for achieving various end results.

Typically, one principal requirement imposed upon elongated, large diameter, hollow tubes or conduits is a high degree of thermal insulation. In this regard, many pipes, conduits, refrigeration lines, tanks, domes, and the like require substantial thermal insulation in order to assure a smooth continuous long-term operation. As a result, the elongated, large diameter, hollow tubes or conduits which are employed for peripherally surrounding these products must possess a high level of thermal insulation for the pipe assembly about which the product is mounted.

In addition to thermal insulation of ever increasing magnitude, the large diameter, elongated, hollow tubes or conduits being demanded in the industry are also required to possess specific limits on the vapor transmission rates through the tube or conduits in order to protect the pipe about which tubes or conduits have been mounted. Furthermore, other requirements such as thermal expansion, controlled rates of diffusion, dimensional stability, nested engagement, ease of sealing, etc., are additional physical and structural characteristics, qualities and properties a commercially desirable elongated, large diameter hollow tube or conduit must possess in order to satisfy the demands imposed on these products for use in these industries.

Therefore, it is a principal object of the present invention to provide elongated, large diameter, hollow tubes or conduits and manufacturing methods therefor which possess virtually any desired physical and structural characteristics, qualities and/or properties required by end users.

Another object of the present invention is to provide elongated, large diameter, hollow tubes or conduits and manufacturing methods therefore having the characteristic features described above which possesses a plurality of separate components integrally formed with each other.

Another object of the present invention is to provide elongated, large diameter, hollow tubes or conduits and manufacturing methods therefor having the characteristic features described above which incorporates foam plastic material as one of the principal components thereof.

Another object of the present invention is to provide elongated, large diameter, hollow tubes or conduits and manufacturing methods therefor having the characteristic features described above which is capable of being employed with minimum manpower requirements and optimum production rates.

Other and more specific objects will in part be obvious and will in part appear hereinafter.

### SUMMARY OF THE INVENTION

By employing the present invention, all of the difficulties and drawbacks found in prior art systems are eliminated and an elongated, hollow, large diameter, multi-component and/or multi-layer tube or conduit is achieved incorporating foamed plastic material as at least one component or layer thereof. In the present invention, the multi-component and/or multi-layer tube or conduit is constructed for possessing specific physical and structural attributes particularly suited to the needs of one or more industries or technological areas. As a result, prior art expensive manufacturing methods are completely eliminated and an effective, cost-efficient, multi-component/multi-layer tube or conduit having precisely desired requirements is realized.

In accordance with the present invention, the unique spiral forming process taught in U.S. Pat. Nos. 6,306,235 and 6,537,405 is employed, along with newly added improvements which are not taught or suggested in these prior art patents. Although some specific details regarding these prior art processes are discussed herein, aspects of the teaching contained in these patents will not be repeated. Consequently, all of the relevant teaching contained in the above identified patents is incorporated herein by reference in order to provide a full and complete disclosure of the present invention.

As fully detailed in this disclosure, a wide variety of various materials, forms, profiles, composites, and components can be employed to produce the desired multi-component/multi-layer tube or conduit of the present invention. However, in order to understand the principal operation and the construction of the present invention, the basic multi-component/multi-layer tube or conduit of the present invention is described herein employing at least one thermoplastic foam profile produced by extrusion and having a desired cross-sectional shape and configuration.

In this disclosure, the word “multi-component” is generally employed to refer to the use of two or more profiles or layers which are formed from different base materials. In addition, the word “multi-layer” is generally employed to refer to the use of two or more profiles or layers which are formed from similar or identical materials. As a result, and as is evident from this disclosure, the present invention can be formed from a plurality of profiles or layers which comprise the same or similar material, as well as a plurality of profiles or layers which comprise different materials.

As a result, the elongated hollow tube produced by employing the present invention may be constructed in a wide variety of alternate configurations and compositions without departing from the scope of this invention. Furthermore, although the words “multi-component” and “multi-layer” are used throughout this disclosure, it should be understood that in all instance, the elongated, hollow tube may be constructed employing one or more profiles or layers formed from identical materials as well as one or more profiles or layers formed from different materials, regardless of the precise words or descriptions employed in detailing a particular final product.

In accordance with the present invention, a desired foam profile having a desired cross-sectional shape and configuration is produced by extrusion and either delivered directly to the forming equipment or placed in storage for subsequent use. In fact, as is more fully detailed below, storage of the extruded foam profile prior to use has been found to be extremely desirable for controlling and/or eliminating some of the inherent difficulties found with using extruded foam profiles immediately after formation. However, regardless of which procedure is employed, the foamed profile is delivered to a rotating cylindrical sleeve which comprises a principal component of the spiral forming manufacturing equipment employed in the present invention.

In order to form the desired tube or conduit, the foam profile is wrapped peripherally surrounding the rotating sleeve or mandrel, with the abutting edges of the profile being continuously fused to each other in the spiral forming manufacturing operation. By continuously advancing the elongated extruded profile onto the rotating cylindrical sleeve, the side edges of the incoming profile are bonded to the edge of the adjacent wrapped profile in a continuous, spiral forming manner. By continuing this operation, a tube or conduit having any desired overall length is achieved.

In accordance with the improvements of the present invention, an elongated, hollow tube or conduit having any desired predetermined physical characteristics, qualities, and inherent structural capabilities is produced. In order to attain this unique and previously unanticipated result, the desired elongated, hollow tube or conduit is produced by simultaneously bonding a second profile to the first profile, in a manner substantially equivalent to the production of the first profile.

In this regard, the first profile forms a first layer of a multi-component/multi-layer elongated, hollow tube or conduit, with the second profile being bonded to the first profile as well as to the side edges of the second profile for effectively achieving a tube or conduit with two separate and distinct layers integrally bonded to each other. By selecting profiles or layers having specific physical or structural characteristics and capabilities, unique multi-component/multi-layer tube or conduit products are realized. Furthermore, as is more fully discussed below, a plurality of separate and independent profiles or layers can be integrally bonded to each other in this manner in order to achieve a final product having specific physical and/or structural characteristics and qualities.

By employing this unique spiral forming process, a hollow, cylindrical, multi-component/multi-layer tube or conduit is formed on a continuous basis, with the length thereof being controlled only by the need of the customer. In addition, any desired diameter can be formed by employing a rotating sleeve or mandrel constructed with an external diameter substantially equivalent to the internal diameter for the desired product. Furthermore, the overall thickness of the final product and its overall diameter is controlled by the thickness of the profiles employed for forming the final product, while the shape of the product is controlled by the shape of the rotating sleeve or mandrel.

In accordance with the present invention, a plurality of separate and independent profiles or layers are integrally bonded to each other in a continuous, spiral forming production operation. In the preferred construction, the first profile is bonded to itself in the manner detailed above forming a first layer of the final product. Once at least a portion of this first layer has been established, the second profile is advanced onto the spiral forming equipment peripherally surrounding the first layer, with the side edges of the second profile being bonded to each other. In addition, as the second profile is advanced onto the rotating sleeve or mandrel, the lower surface of the second profile is bonded to the top surface of the first profile. In this regard, depending upon the construction employed for providing the bonded interengagement of the second profile to the first profile, the side edges and the contacting surfaces of the second profile can be simultaneously bonded or, if desired, can be sequentially bonded.

As is evident from the foregoing disclosure, any desired number of profiles or layers can be bonded to each other in order to form a particular final, multicomponent/multi-layer tube or conduit. In addition, the thickness of each profile or layer employed can be varied in order to achieve particular desired results. As is more fully detailed below, the thickness of a profile affects various attributes of the profile, as well as the period of time required for all gases to be disbursed therefrom. With thicker profiles being generally less desirable than thin profiles, the present invention can employ a plurality of profiles of any desired thickness in order to achieve an optimum final product construction. As a result, difficulties and drawbacks found in prior art systems are completely eliminated and a highly desirable, multi-component/multi-layer tube or conduit is attained.

In producing the elongated, hollow, multi-component/multi-layer tubes or conduits of the present invention, both foamed and non-foamed layers can be employed and intermixed with each other as desired. Although any desired materials can be employed, foamed layers preferably comprise one more selected from the group consisting of polypropylene, polyethylene, cross linking polyethylene, cross linking polypropylene, polystyrene, polyurethane, melamine, polyethylene terephthalate (PET), acrylonitrile butadiene styrene (ABS), and ethylene vinyl acetate (EVA). In addition, non-foamed layers preferably comprise one of more selected from the group consisting of aluminum cladding, woven glass, woven fiber, woven cloth, blown fiberglass cloth, polyester films, polyethylene films, polypropylene films, nylon films, silica films, co-extruded films, Mylar, rubber, neoprene rubber, paper, all water and water vapor transmission blocking media, material, and coatings.

Furthermore, if desired, the final hollow, elongated, multi-component/multi-layer tube/conduit of the present invention may incorporate a jacket or outer cladding layer as the final layer forming the outer surface of the resulting product. In this way, any desired physical or structural characteristics for protecting the outer surface of the tube/conduit can be formed as an integral component of the tube/conduit during the production operation. In this way, added ease, convenience, and production simplicity is realized, along with substantially reduced costs which would otherwise be incurred from applying an outer surface to a preformed product.

In order to assure that each of the layers forming the elongated, hollow, multi-component/multi-layer tube/conduit of the present invention are integrally bonded to each other, one or more bonding methods or systems are preferably employed. As discussed above, the multi-components/multi-layers are integrally bonded to each other as well as to themselves, either simultaneously or sequentially. Furthermore, depending upon the materials and applications being used, it has been found that the bonding process preferably comprises one or more selected from the group consisting of heat welding, sonic welding, laser welding, adhesive agents, mechanical agents, chemical agents, and other known methods of joining materials.

Using an alternate embodiment of the present invention, the hollow, cylindrical, multi-component/multi-layer tube/conduit constructed using the teaching of the present invention can be formed comprising virtually any desired overall diameter and wall thickness. In this alternate embodiment of the present invention, a plurality of separate and independent cooperating rotating sleeves or mandrels are employed, spaced apart in any desired configuration, with the cylindrical tube/conduit being formed by wrapping the extruded profiles about the plurality of rotating sleeves or mandrels in a continuous forming operation.

In the simplest form, two separate and independent sleeves/mandrels are employed, positioned in juxtaposed, spaced, relationship to each other, with each sleeve/mandrel rotating about substantially parallel axes. A first profile having the desired cross-sectional shape or configuration is produced and advanced onto the first rotating sleeve/mandrel. Then, instead of being continuously wrapped about the single rotating sleeve/mandrel in a generally spiral configuration, as in the previous embodiment, the elongated extruded profile is advanced from the first sleeve/mandrel to the second sleeve/mandrel. At the second sleeve/mandrel, the extruded foam profile is wrapped about the outer surface thereof a sufficient distance to enable the foam profile to be returned to the first sleeve/mandrel. This process is then continuously repeated, forming an elongated, oval-shaped cylindrical tube having a desired length.

Next, a second profile or layer is advanced onto the first profile or layer for being spirally wound onto the top surface of the first profile. As detailed above, the side edges of the second profile is bonded to each other, with the bottom surface of the second profile being bonded to the top surface of the first profile.

This process is continued until an elongated, oval-shaped, hollow, multicomponent/multi-layer tube/conduit having a desired length is achieved. Furthermore, any additional layers or profiles are added in the same manner to achieve a desired final product.

By employing this continuous spiral forming process, a hollow, generally oval shaped, multi-component/multi-layer cylindrical tube/conduit is formed in a continuous production basis, with any desired length being easily achieved. In addition, the overall dimensions and configuration of the hollow multicomponent/multi-layer tube/conduit being produced is virtually unlimited, with the size and configuration of the tube/conduit being totally dependent upon the relative positions of the plurality of cooperating, rotating sleeves/mandrels. As a result, virtually any configuration or dimension is capable of being created using the unique process and the equipment of the present invention.

As the profile or layer is brought into engagement about the outer surface of the first sleeve/mandrel, as detailed above in reference to the single rotating sleeve/mandrel, the abutting side edges of the profile or layer are continuously affixed to each other. As detailed herein, this affixation process is achieved typically using either mechanical or physical agents or systems. Typically, affixation of the side edges of each profile or layer is achieved using one selected from the group consisting of bonding agents, such as adhesives, glues, and the like, or physical affixation systems such as heating of the side edges to a melt temperature and pressing the side edges to together to integrally affix the foam material to itself. In addition, as discussed, the surfaces of each added profile or layer is affixed to the surface of the underlying profile or layer.

In securely affixing or bonding the profiles or layers to themselves and each other to form the desired enlarged, oval-shaped cylindrical, multicomponent/multi-layer tube/conduit, the affixation or bonding step is preferably achieved in the area of the first rotating sleeve or mandrel. However, the precise location of the affixation/bonding equipment for achieving the desired interengagement may be varied, depending upon the process being employed.

In general, it has been found that the profiles or layers may be affixed to each other as the profile/layer is advanced into engagement with the first rotating sleeve/mandrel. However, if desired, in the use of an alternate embodiment may be employed wherein the affixation system may be positioned between the first and second rotating sleeves/mandrels without departing from the scope of this invention. Furthermore, any alternate configuration or position for the affixation equipment can be implemented, without departing from the scope of this invention.

In one preferred embodiment of the present invention, two separate and independent rotating sleeves or mandrels are employed with one mandrel being rotationally mounted in a fixed location, while the second sleeve/mandrel is mounted for cooperative rotation with the first sleeve/mandrel while also being movable into a plurality of alternate positions. Preferably, the movable sleeve/mandrel is movable in its entirety along a single plane, enabling the central axis thereof to be in the same plane as the central axis of the first sleeve/mandrel, regardless of the position of the second sleeve-mandrel.

In this way, the spaced distance between the central axis of each of the two rotating sleeves/mandrels can be varied by the user, depending upon the size of the oval-shaped conduit/tube desired for production. By employing this configuration of the present invention, the overall diameter of the oval-shaped tube or conduit being produced is capable of being easily adjusted through a wide range of alternate diameters.

As is evident from this disclosure, a highly efficient, low-cost manufacturing process is realized which is capable of producing hollow cylindrical tubes/conduits formed of any desired materials and/or any desired layers with the tube or conduit comprising any desired thickness and any desired diameter. Furthermore, by cutting the elongated formed tube at any desired length, products are produced to the precise specification desired by the customer.

In addition to providing a hollow cylindrically shaped, elongated multicomponent/multi-layer tube/conduit having any desired diameter, wall thickness, and length sought by a customer, the process of the present invention also achieves a hollow cylindrical tube member having any cross-sectional shape, configuration, or aperture pattern desired by a customer. As is well known in the art, extrusions may be formed with any desired cross-sectional shape, overall configuration, aperture pattern and the like as part of the formation process. Consequently, by employing these known formation techniques in combination with the spiral forming process of the present invention, cylindrical tubes may be formed incorporating a particularly desired pattern or configuration. In this way, enhanced flexibility and product design capabilities far beyond current manufacturing techniques are attained by employing the present invention.

As is evident from the foregoing disclosure, the present invention is capable of achieving multi-component/multi-layer hollow cylindrical tubes in any desired diameter and thickness as well as substantially flat sheets or planks of multi-component/multi-layer materials in any desired thickness, configuration, or visual appearance in a manner which is produced economically, simply, and directly without employing expensive, specially designed equipment. Furthermore, scrap material is reduced, and smaller batches or quantities of material can be manufactured in any color, size, product formulation, etc. desired by a user. Since small quantities can be produced, extensive inventories are eliminated and significant cost reductions are realized.

The invention accordingly comprises the several steps and the relation of one or more of such steps with respect to each of the others, and the apparatus embodying features of construction, combinations of elements and arrangements of parts which are adapted to effect such steps, all as exemplified in the following detailed disclosure, and the scope of the invention will be indicated in the claims.

### THE DRAWINGS

For a fuller understanding of the nature and objects of the present invention, reference should be had to the following detailed description taken in connection with the accompanying drawings, in which:

FIG. 1 is a perspective view of the manufacturing equipment employed in producing the multi-component/multi-layer spiral formed cylindrical tubes in accordance with the present invention;

FIG. 2 is a side elevation view of the manufacturing equipment of FIG. 1;

FIG. 3 is an end in view of the manufacturing equipment of FIG. 1;

FIG. 4 is a perspective view, partially cut away, depicting a typical multi-component/multi-layer spiral formed cylindrical tube manufactured using the teaching of the present invention;

FIG. 5 is a perspective view, partially cut away, depicting a further embodiment of a multi-component/multi-layer spiral formed cylindrical tube manufactured using the teaching of the present invention;

FIG. 6 is a perspective view of a fully assembled multi-component/multi-layer spiral formed cylindrical tube manufactured using the teaching of the present invention and incorporating an outer sealing construction;

FIG. 7 is a perspective view of an elongated profile incorporating a plurality of upstanding fins or flanges on one surface thereof; and

FIG. 8 is a front elevation view of the profile of FIG. 7 depicting alternately constructed fins or flanges.

### DETAILED DESCRIPTION

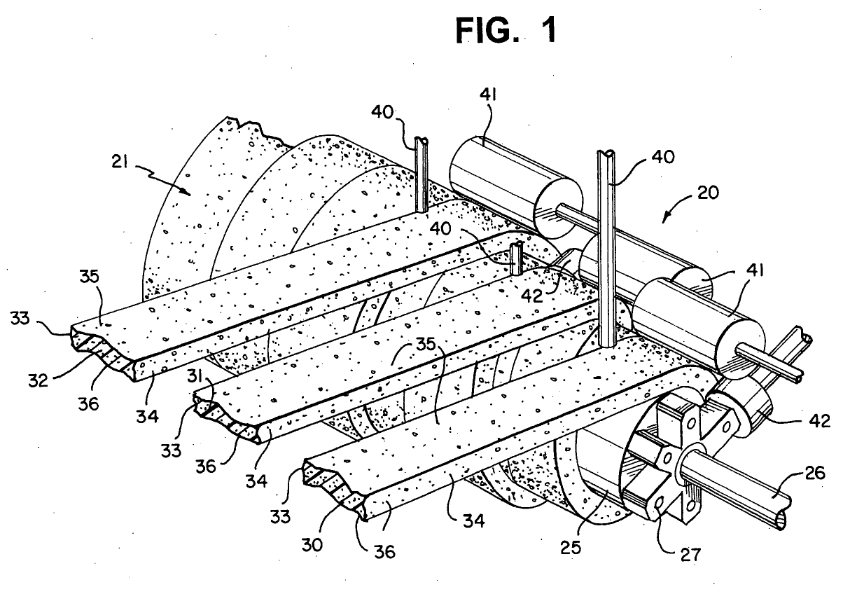

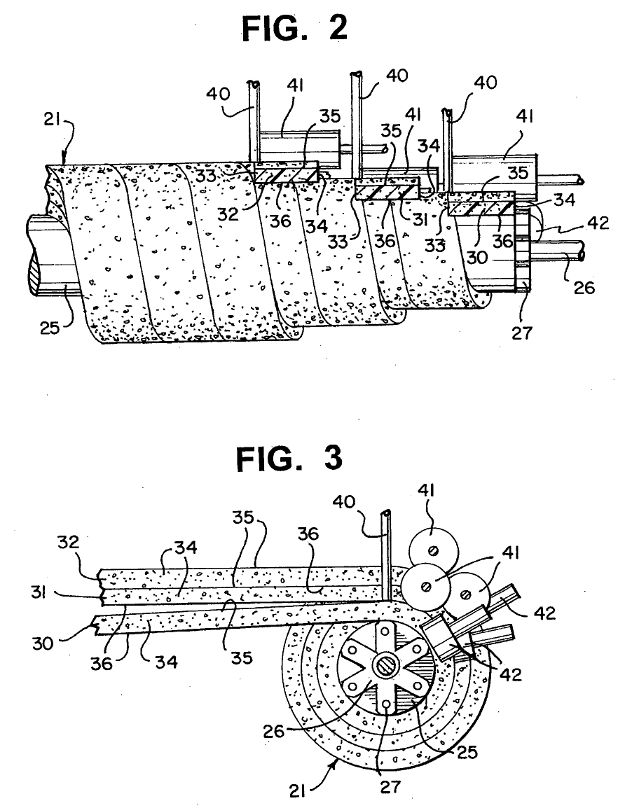

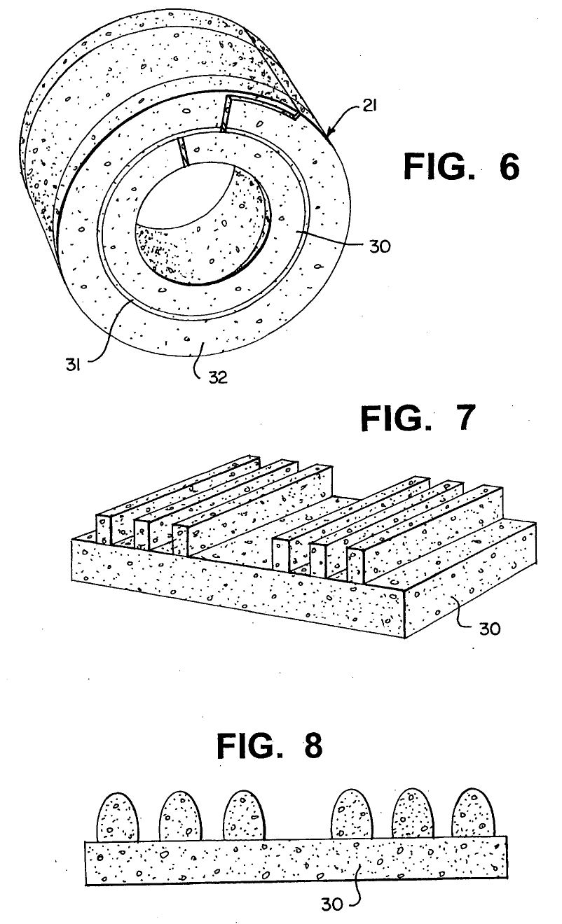

By referring to FIGS. 1-8, along with the following detailed disclosure, the construction of the manufacturing equipment, the process of the present invention, and the uniquely constructed multi-component/multi-layer products attainable with the present invention can all be best understood. However, as will become evident from this detailed disclosure, variations may be made in the manufacturing equipment, the method steps, and the resulting products, without departing from the scope of this invention. Consequently, the disclosure provided herein as well as shown in FIGS. 1-8, are provided for exemplary purposes only in assuring a full and complete disclosure of the present invention, and are not intended as, nor should be considered as, a limitation of the present invention to be specifically disclosed material.

In FIGS. 1-3, the preferred embodiment of product forming system 20 of the present invention is fully disclosed in the process of forming elongated, hollow, multi-component/multi-layer tube 21 of the present invention. As depicted, in this embodiment, product forming system 20 comprises an elongated sleeve or mandrel 25 mounted to shaft 26 with supporting arm assembly 27 affixed to shaft 26 and extending therefrom into supporting and driving engagement with mandrel 25. By continuously rotating shaft 26 in the desired direction, mandrel 25 continuously rotates therewith for enabling elongated, hollow, multi-component/multi-layer tube 21 to be formed.

As depicted, a plurality of elongated, continuous, profiles or layers 30, 31, and 32 are fed onto rotating mandrel 25 and welded to each other, as a detailed herein. As will become evident from the following detailed disclosure, although three separate and independent profiles or layers 30, 31, and 32 are shown and fully disclosed, any desired number of profiles or layers can be employed without departing from the scope of this invention.

In order to achieve the desired elongated, hollow, multi-component/multi-layer tube 21 of the present invention, product forming system 20 is constructed for receiving profile 30 on mandrel 25 as mandrel 25 is continuously rotated. If desired, mandrel 25 can be maintained stationary, while profile 30, as well as the additional profiles, are rotated about stationary mandrel 25. Although this alternate arrangement can be employed, it has been found to be preferable for mandrel 25 to be continuously rotated, for assuring that profiles 30, 31, and 32 rotate at the precisely desired rate of speed.

As shown, profile 30 is advanced onto mandrel 25 in a manner which causes profile 30 to be wrapped about mandrel 25 of product forming system 20, continuously forming a plurality of spirally wound convolutions in a side to side abutting relationship with each other. In this way, the incoming continuous feed of profile 30 is automatically rotated about mandrel 25 in a generally spiral configuration, causing side edge 33 of the incoming profile 30 to be brought into abutting contact with side edge 34 of the previously received and wrapped convolution. By bonding abutting side edges 33 and 34 to each other at this juncture point, the first layer of the desired substantially cylindrically shaped, hollow tube is formed.

In order to provide the integral bonded interengagement of side edges 33 and 34 of first profile 30, a bonding or fusion element 40 is preferably employed. In accordance with the present invention, bonding/fusion element 40 may comprise a variety of alternate constructions in order to attain the desired secure, affixed, bonded interengagement of edge 33 with edge 34.

In one preferred embodiment, as depicted in FIGS. 1-3, bonding/fusion element 40 employs an elongated nozzle through which heated air is fed, exiting through portals formed at the terminating end thereof for direct delivery to side edges 33 and 34 of profile 30. In this way, the side edges of profile 30 reach their melting temperature and are then securely fused to each other. Alternatively, bonding/fusion element 40 may comprise a heated wire which is employed for contacting side edges 33 and 34 for raising their temperatures and enabling the side edges to be melted and bonded to each other.

If desired, bonding/fusion element 40 may comprise a wide variety of alternate sources for heating or bonding edges 33 and 34 to each other. Although any bonding system can be employed, the preferred bonding system comprises one or more selected from the group consisting of heat welding, sonic welding, laser welding, adhesive bonding, mechanical bonding, chemical bonding, or any other method for securely affixing the surfaces of profile 30 to each other.

As the manufacturing process continues and additional convolutions of profile 30 are spirally wound on mandrel 25 with the side edges thereof being fused to each other, the cylindrically shaped formed body continuously advances along the length of mandrel 25. Once a sufficient number of convolutions of profile 30 have been wound about mandrel 25 in bonded engagement with each other, second profile 31 is delivered to product forming system 20.

As depicted, second profile 31 is advanced onto the outer surface of first profile 30 in a manner which causes profile 31 to be wrapped about profile 30, continuously forming a second layer of spirally wound convolutions in side to side abutting relationship with each other. As the incoming continuous feed of profile 31 is automatically rotated about the outer surface of profile 30 in a generally spiral configuration, the side edge 33 of incoming profile 31 is brought into abutting contact with side edge 34 of the previously received and wrapped convolution of profile 31. By bonding abutting side edges 33 and 34 of profile 31 to each other at this juncture point, the second layer of the desired substantially cylindrically shaped hollow tube is formed.

In the preferred embodiment, bottom surface 36 of second profile 31 is bonded to top surface 35 of first profile 30 as second profile 31 is advanced and spirally wound onto first profile 30. As more fully discussed below, in the preferred embodiment, the bonded interengagement of bottom surface 36 of second profile 31 with top surface 35 of first profile 30 is achieved simultaneously with the bonding of side edges 33 and 34 of second layer 31 to each other. However, if desired, the bonding operations can be achieved sequentially, as opposed to simultaneously.

Once a sufficient number of convolutions of second profile 31 have been wound about first profile 30, as well as bonded to itself and first profile 30, third profile 32 is advanced onto second profile 31 in a manner which causes third profile 32 to be wrapped about second profile 31, continuously forming a plurality of spirally wound convolutions in a side to side abutting relationship with each other. In this way, the incoming continuous feed of third profile 32 is automatically rotated about second profile 31 in a generally spiral configuration, causing side edge 33 of incoming third profile 32 to be brought into abutting contact with side edge 34 of the previously received and wrapped convolution thereof. By bonding abutting side edges 33 and 34 of third profile 32 to each other at this juncture point, the third layer of the desired substantially cylindrically shaped hollow tube is formed.

In addition, as detailed above, bottom surface 36 of third profile 32 is preferably bonded to top surface 35 of second profile 31 as a third profile 32 is advanced and spirally wound onto second profile 31. Preferably, the bonded interengagement of bottom surface 36 of third profile 32 with top surface 35 of second profile 31 is achieved simultaneously with the bonding of side edges 33 and 34 of third profile 32 to each other. However, if desired, the bonding operation can be achieved sequentially, as opposed to simultaneously.

As is evident from the foregoing detailed discussion, by employing the present invention, an elongated, hollow, multi-component/multi-layer tube is efficiently formed in a manner which completely eliminates all of the prior art difficulties and drawbacks. Furthermore, using the teaching of this invention, a wide variety of alternate configurations, constructions, and material combinations can be effectively and efficiently produced in a unitary, fully integrated product.

Although FIGS. 1-3, as well as the foregoing detailed discussion, depicts mandrel 25 with a substantially cylindrical shape, mandrel 25 may comprise any desired shape for achieving an elongated, hollow, multicomponent/multi-layer tube with any desired cross-sectional shape. In this regard, mandrel 25 may be constructed with a cross-sectional shape which is substantially a flat plate with two sides, a triangular shape with three sides, a square or rectangular shape with four sides, a pentagonal shape with five sides, a hexagonal shape with six sides, or any other desired configuration having either a regular or irregular configuration. However, regardless of the configuration employed for mandrel 25, the operation detailed above would be employed with virtually no changes.

By employing the present invention, elongated, hollow, multi-component/multi-layer tube 21 is produced with any desired configuration, composition, or combinations thereof. In this regard, as discussed above, the present invention generally refers to “multi-layer” as a plurality of separate profiles or layers of identical or similar compositions. In addition, in reference to “multi-component”, a construction is contemplated wherein layers of distinctly different materials forming different components of a single, fully integrated product are produced. As a result, and as is evident from this detailed discussion, the present invention comprises elongated, hollow, tubes, conduits, and the like, which are multi-component/multi-layer and/or any combination thereof desired by the user. In this way, any requirements imposed upon a product for a wide variety of industries is capable of being easily and efficiently produced by employing the present invention.

In general, it has been found that traditional prior art extrusion systems are limited to producing products having a maximum inside diameter of about 6 inches and a wall thickness of about 1 inch. Furthermore, it has also been found that when traditional prior art extrusion production equipment is employed for achieving products at the limits of the equipment capability, process parameters are often difficult to maintain, leading to variability in the finished product. Typically, physical aspects that will vary based upon the process being employed are wall thickness, cell size, density, and profile consistency.

When variations of this nature occur, the K value and the resulting R value of the products vary significantly. As a result, when products of this nature are to be used for purposes of insulation, it is important that the K value of the product is consistent and predictable. Otherwise, the insulation capability of the product becomes questionable.

By employing the present invention, a plurality of separate and independent profiles or layers are fused together to form an elongated, hollow tube having any desired overall thickness. As a result, each profile comprises a thickness and overall width which can be optimized to provide the best performance characteristics for enhancing the final product. In addition, once the profiles have been fused together, any desired thickness is realized.

Some of the benefits which are attained by employing a plurality of separate layers fused together to form an elongated, hollow, multi-layer tube include controlled cell size, controlled density, and formulation processability. In this regard, the size of the cells of the profile can be controlled for achieving any desired K factor. In this regard, it has been found that up to a 30% increase in the K value for a particular cell size can be attained.

In addition, the density of each profile can be tightly controlled, which can improve the K value up to 5%. Furthermore, specific control of the density also improves the manufacturing of the final product by providing consistent and repeatable results. Finally, product formulations can be widely varied for each profile with some of the profiles incorporating more exotic materials to attain specialized results. In this regard, flame retardants, UV inhibitors, or colors may be added to achieve specific product enhancements. Furthermore, metal flakes, such as aluminum, can be incorporated into the process for improving K values up to an additional 10%.

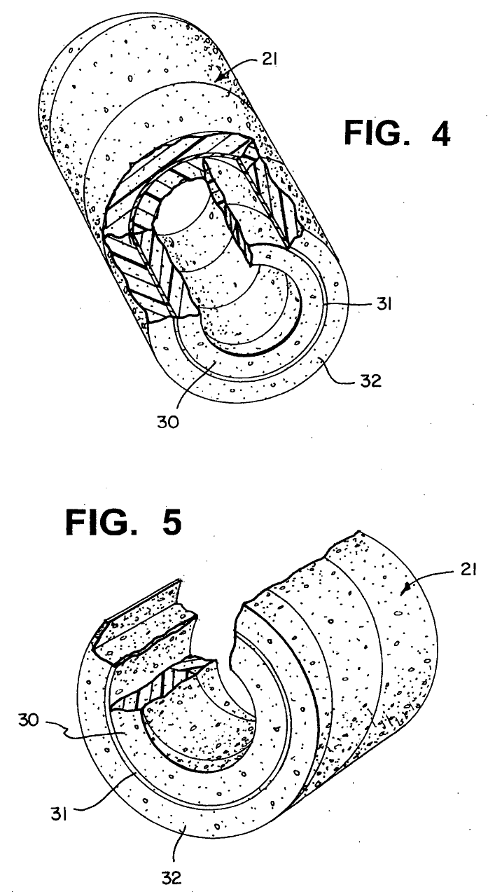

Any desired foam or non-foam material can be employed in producing the final elongated, hollow, multi-component and/or multi-layer tube of the present invention. In addition, the thickness of each layer or combination of layers can be varied in order to attain any particular result. In this regard, as shown in FIGS. 4-8, two foam layers can be formed with a solid or densified, non-foam interstitial layer formed therebetween or, if desired, the inner layer may comprise a plank incorporating a plurality of upstanding flanges. In this way, the resulting product can be constructed for providing a tight fit for any irregularly shaped pipe construction. Furthermore, if desired, an outer jacket or cladding can also be formed on the product as the final layer.

In producing products which employ the teaching of the present invention, virtually any desired material can be employed which is capable of being formed onto the tube member in the manner detailed above. In general, it has been found that foam layers preferably comprise one or more materials selected from the group consisting of polypropylene, polyethylene, cross linking polyethylene, cross-linking poly-propylene, polystyrene, polyurethane, melamine, polyethylene terephthalate (PET), acrylonitrile butadiene styrene (ABS), and ethylene vinyl acetate (EVA). In addition, other foam plastic materials may include one or more selected from the group consisting of polyolefins, polybutylenes polybutanes, thermoplastic elastomers, thermoplastic polyesters, thermoplastic polyurethanes, ethylene acrylic copolymers, ethylene methyl acrylate copolymers, ethylene butyl acrylate copolymers, and ionomers. Furthermore, it has also been found that non-foam layers preferably employed in the present invention comprise one or more materials selected from the group consisting of aluminum cladding, woven glass, woven fibers, woven cloth, blown fiberglass cloth, polyester films, polyethylene films, polypropylene films, nylon films, silica films, co-extruded films, Mylar, neoprene, rubber, paper, all water and water vapor transmission blocking media, material, and coatings.

Another feature of the present invention is the ability to position each layer or profile 30, 31, and 32 in any desired location relative to the underlying profile. In this regard, once first profile 30 has been spirally wound onto mandrel 25, second profile 31 is advanced into spiral overlying engagement with first profile 30.

In this regard, the side edges of second profile 31 can be vertically aligned with the side edges of first profile 30 if so desired by the user or customer. Similarly, third profile 32, and any additional profile mounted thereto can also be vertically aligned with the previous profiles, so as to have a substantially continuous vertical edge formed substantially perpendicularly to the longitudinal axis of the elongated hollow tube.

Alternatively, second profile 31 is affixed to first profile 30 with the side edges of second profile 31 being offset from the side edges of first profile 30. Similarly, third profile 32 would have its side edges offset from the side edges of second profile 31. In general, it has been found that offsetting the side edges of each additional profile from the side edges of the underlying profile is preferred for eliminating or substantially reducing any thermal breaks that would otherwise occur in the final product. However, if desired, vertical alignment of the side edges can be provided.

As discussed above, in the preferred construction, profiles or layers 30, 31, and 32 are bonded or welded to each other along adjacent side edges, as well as along adjacent top and bottom surfaces. In this way, each of the profiles or layers are securely bonded to each other along all interfaces. It has been found that these multiple welds can be achieved either simultaneously or sequentially, using such welding or fusion systems as heaters, air sources, nozzle delivery systems, and various chemical bonding delivery systems. In addition, a plurality of rollers, such as compression rollers, push-off rollers, guide rollers, and the like are employed to assure intimate bonded contact and interengagement between each profile or layer at each juncture surface.

In this regard, as shown in FIGS. 1-3, surface rollers 41 are depicted in contact with top surface 35 of profile or layers 30, 31, and 32, in order to assure secure contact of each layer or profile with the surface to which the layer or profile is being applied. In addition, edge rollers 42 are also employed for contacting side edges 34 of each profile or layer as the profile or layer is advanced onto the tube assembly. By properly positioning edge roller 42, intimate bonded interengagement of side edge 33 with side edge 34 of the adjacent convolution is assured.

In the preferred construction, bottom surface 36 of second profile/layer 31 is bonded to top surface 35 of first layer/profile 30 simultaneously with the bonding of the side edges of second profile/layer 31. In order to achieve this simultaneous bonded interengagement, a single L-shaped heating nozzle is employed, as depicted in FIGS. 1 and 2, in order to deliver heated air to both surfaces for simultaneous bonding. If desired, separate bonding zones and/or bonding apparatus can be employed, if so desired. However, the bonding of all adjacent surfaces simultaneously has been found to be preferred.

In forming elongated, hollow, multi-component/multi-layer tube 21 in accordance with the present invention, profiles/layers 30, 31, and 32, as well as any other additional profiles or layers desired, are delivered to rotating mandrel 25 in a wide variety of alternate production or delivery methods. In this regard, in one principal delivery system, each profile/layer is fed directly from a separate extruder to rotating mandrel 25. In this way, a constant supply of the material for each profile/layer is provided with the forming operation continuing on a constant basis, forming any desired elongated length for multi-component/multi-layer tube 21.

In an alternate delivery system, each profile or layer is formed on an extruder, or other equipment, and rolled into one or more large spools of material. In a further alternate configuration, each profile or layer is formed on an extruder, or other equipment, and cut into elongated, continuous, substantially flat length of material which are stacked in aligned relationship with each other. Profile includes any type of solid or hollow, tube, square, hexagon, rectangle, and irregular shapes, etc.

In both of these delivery methods, the pre-formed product is typically stored for future use and, when desired, the stored spools or stack length of a material are delivered to the rotating mandrel for being fed onto the mandrel to achieve the desired elongated, hollow, multi-component/multi-layer tube 21. Furthermore, if desired, any combination of these delivery systems can be employed with equal efficacy.

In addition, depending upon the length desired for the elongated, hollow, multi-component/multi-layer tube 21, a delivery system as detailed above can be employed for providing continuous feeding of the extruded product, a semi-continuous feeding, or incremental feeding. Depending on the conditions and the product desired, each of the systems can be employed for achieving the most effective result.

One of the principal benefits achieved by employing the present invention is the ability to build thick profiles using a plurality of thinner profiles. This ability is extremely important as briefly discussed above, due to many factors which exhibit improved capabilities in a thin profile over thick profile. One such factor is the rate of outgassing which results from a comparison of thin profiles to thick profiles.

In this regard, it is well known in the art, that various gases or blowing agents are employed during the foam extrusion process with the gases being embedded within the resulting product once the product exits the extrusion equipment. Typically, it is preferred that these gases or blowing agents are allowed to dissipate from the profile or layer before using the profiles/layer in a subsequent processing step. Furthermore, in some applications, flammable blowing agents are used which must be allowed to dissipate or defuse from the profiles/layer prior to use the formed product.

In general, it has been found that the rate of diffusion of the gases from the foam profile or layer increases as the thickness of the profiles/layer decreases. Furthermore, the rate of diffusion increases by the square of the change in thickness. As a result, by reducing the thickness of a particular foam/profile, the time required before all of the gases have dissipated and the product can be safely shipped is significantly reduced.

By employing the present invention, this substantially inherent advantageous result can be optimized, by forming profiles/layers with comparatively thin cross-sectional shapes and fusing the thin profiles/layers together to achieve a product having any desired thickness. In this way, safer production of the product is achieved and a commercially desirable multi-layer product is attained with optimum beneficial results.

Another problem which is inherent in the use of thicker profiles or layers is the effect that rotational speed produces. In this regard, as a thicker profile is wrapped about a rotating mandrel, added tension is produced on the outside surface thereof while some compression is produced on the inside surface thereof. This result is inherently due to the difference in speed at which the surfaces are moving as the profile is wrapped on the mandrel. However, by employing the present invention and using a plurality of thinner profiles which are welded together, this problem is completely eliminated.

It is well-known that foam extrusion products are produced by creating a plurality of bubbles or cells in a matrix which expands as the foam product expands out of the orifice of the extruder. During this expansion, these cells are oriented along the direction of flow of the product out of the extruder, with the cells being longer or oval shaped along the extrusion axis. In addition, the cells tend to be substantially round or circular in shape in the axis or plane perpendicular to the product flow.

As a result of this phenomenon, a foam extrusion profile or layer tends to have large dimensional movement in its longitudinal direction and substantially less expansion and/or contraction in its transverse direction. By employing the present invention, this inherent stability in the transverse direction is advantageously used since the elongated profile is wrapped about a mandrel for forming the elongated tube, with each of the convolutions forming the elongated tube comprising the transverse cross-sectional dimension of the profile or layer. As a result, the overall dimensional stability of the elongated, hollow, multicomponent/multi-layer tube of the present invention along its length is inherently stable as formed, and subject to substantially less dimensional instability that might otherwise occur.

Two factors which are important in the commercial use and applicability of the products of the present invention are dimensional stability and coefficient of thermal expansion. In general, dimensional stability is defined as the shrinkage or expansion of a product over time, while the coefficient of thermal expansion is the shrinkage or expansion of a product resulting from increasing or decreasing the temperature to which the product is exposed. The reason these factors are important is due to the dimensional changes a product would experience and the effect these dimensional changes may have on the use of the product in a particular application.

As is evident from the foregoing detailed discussion, by employing a plurality of thinner profiles or layers which are fused to each other, substantial advantageous results are realized, since thinner layers are inherently more stable and therefore subject to less dimensional changes after production. As a result, the dimensions of the finished product will be more stable and less likely to change.

Another benefit which is obtained using the teaching of the present invention is the ability to employ profiles or layers formed from different materials to achieve a single elongated, hollow, multi-component/multi-layer tube. As a result, profiles or layers which are constructed from materials which are inherently more stable or have greater dimensional stability are easily intermixed with other profiles or layers which are less dimensionally stable. As a result, by intimately bonding profiles or layers in the manner detailed above, with one profile or layer peripherally surrounding and enveloping the underlying profile or layer, the profile or layer with the greater inherent dimensional stability will effectively control or limit the less dimensionally stable profile or layer. In this construction, the less dimensionally stable profile or layer is restrained from expanding or contracting to the full extent the profile or layer would normally experience due to the control thereof by the more dimensionally stable profile. As result, an overall final product having greater dimensional stability is realized.

Furthermore, by forming elongated, hollow, multi-component/multi-layer tube 21 of the present invention in the manner detailed above, a final product having virtually any desired dimensional stability can be realized. By properly selecting the materials from which each profile or layer is formed, complete control over the dimensional stability of the final product is realized.

It has also been found that the bonding interengagement of each individual profile or layer employed in forming the elongated, hollow, multicomponent/multi-layer tube of the present invention contributes inherently to the dimensional stability of the final product. In this regard, the bonding of top surface 35 of one profile/layer to bottom surface 36 of an adjacent profile/layer causes a densification of both surfaces along the entire joined area. As a result of this bonded or welded interengagement, the area becomes very rigid and has high compressive and tensile strength.

Typically, the foam material itself is low-density and has greater flexibility and less compressive and tensile strength than the welded area. The matrix formed by the plurality of welded zones will expand and contract less than a similar sized piece of foam material. As result, the welded areas will have a greater contribution to limiting the amount of thermal expansion, when heated, and thermal contraction, when allowed to cool, then would be experienced by the foam itself. Consequently, the addition of these welded zones and laminated layers greatly improves the coefficient of thermal expansion of the resulting product.

In another aspect of the present invention, one of the profiles or layers employed in forming elongated, hollow, multi-component/multi-layer tube 21 of the present invention may comprise a thin film or other densified material which is sandwiched between two foam profiles or layers to impart dimensional stability or other physical or structural characteristics desired for the final product. In this regard, woven materials, non-woven materials, extruded materials, natural or artificial fibers, metallized materials, composite materials, and the like can be employed for providing specific structural or physical properties to the final product. Furthermore, infrared or microwave reflective material can also be formed therein to impart desired properties to the final product.

By employing one or more of these interstitial layers in the final product, a wide variety of structural and/or physical properties can be enhanced. One example of such an enhancement would be controlling vapor transmission, by using a layer of material which is known to have limited or virtually no water transmission. By employing an interstitial layer which performs a vapor barrier functions, the resulting product can be manufactured which virtually eliminates vapor transmission.

Furthermore, layers of material which are otherwise incompatible with the base material can also be incorporated into the final product. In this regard, materials that are otherwise incompatible with typical foam profiles or layers can be integrally bonded between the profiles or layers as a component thereof. In this way, materials such as open weave carbon fiber cloth, fiberglass, carbon fiber materials, Kevlar, blown glass fibers, or other similar material can be incorporated into the elongated, hollow, multi-component/multi-layer tube to further enhance the product as desired.

A further advantage which is achieved by employing the present invention is the ability to integrally bond two profiles or layers which are otherwise incompatible and incapable of being bonded to each other. In order to attain this bonded interengagement, a separate independent interstitial layer, also called a tie layer in the plastics industry, is employed which is either capable of being bonded to the two adjacent layers or comprises a thin composite film formed by one or more materials which will enable the two profiles to be bonded to the interstitial layer.

In this regard, the thin interstitial layer may comprise two materials fused together each of which are bondable to one of the profiles or layers to be integrally joined. Alternatively, thin films of a first compatible bonding material can be joined to a support film on which another compatible material is affixed thereto, with each of these materials being bondable to the profiles which are otherwise incapable of being joined. In this way, a fully integrated, integrally bonded multi-layer construction is realized with layers or profiles formed from materials which otherwise would be incapable of being produced in a single elongated, hollow, tube product.

In addition to the incorporation of any desired interstitial layer which can be integrally formed between any desired foam or non-foamed layer, the present invention also enables any desired outer jacket or cladding layer to be integrally formed as a further integral component of the elongated, hollow, multicomponent/multi-layer tube 21 of the present invention. In addition to enabling any desired composition to be employed in order to provide any particular physical or structural properties to the outer surface of the elongated, hollow, multi-component/multi-layer tube 21 of the present invention, the present invention also enables any desired sealing system to be incorporated into the outer jacket or cladding layer in order to provide ease of installation and affixation of tube 21 in a desired location or about a desired pipe.

In this regard, in many applications, elongated, hollow, multicomponent/multi-layer tube 21 is installed peripherally surrounding a particular elongated pipe in order to provide insulation, weather protection, etc. to the pipe member itself. In order to assure rapid installation of tube 21 in the desired location, a longitudinally extending slit is typically formed in the tube extending from the outer peripheral surface to the inside diameter. In this way, tube 21 is quickly and easily mounted to the pipe in peripheral surrounding engagement therewith. In addition, a sealing system is often employed for closing the longitudinally extending slit and securely affixing tube 21 securely about the pipe member.

Typically, a wide variety of alternate configurations are employed for sealing systems, including flaps integrally formed on one side of the jacket or cladding which overlies the longitudinally extending slit and joins one side of the tube member to the other side thereof. In addition, external adhesive fastening members are also employed, as well as various interlocking configurations and constructions for providing the desired sealing of the tube member. However, regardless of which sealing construction is desired, the present invention enables any desired sealing system to be easily incorporated into the elongated, hollow, multi-component/multi-layered tube product made in accordance with the present invention.

In order to assure optimum performance in many applications, specific orientation of the elongated slit of a tube member are required in installations in which thick tube members are employed peripherally surrounding a pipe member. In this regard, in these applications it is typically required that a plurality of tube members be mounted in stacked, peripheral surrounding interengagement with each other, with the longitudinally extending slit of each tube member being offset by at least 90° from the underlying tube member. In this way, optimum thermal resistance is achieved and a continuous thermal path from the outside ambient conditions to the pipe is avoided. By employing the present invention, this offset stacking requirement is easily achieved, as well as rapid sealing of each component during its installation.

In addition, another problem that has occurred with the stacking or peripheral surrounding engagement of a plurality of tube members is the difficulty tube members have in stacking or nesting securely or intimately with each other when in peripheral surrounding interengagement. In this regard, due to tolerances which are inherent in the production of any tube member, as well as the pipe itself, the ability of an inside diameter to securely interconnect or engage with the outside diameter of an underlying tube member or pipe has been found to be difficult, without gaps occurring.

Furthermore, when one tube member is mounted in peripheral surrounding engagement about another tube member, a tight fit is desired. However, if the fit is too tight, the outer tube member may be unable to have its longitudinal slit fully closed. By employing the present invention, these prior art difficulties and drawbacks are easily overcome.

In this regard, it has been found that by incorporating an inside surface which is formed with a particular shape, such as a sawtooth shape, a sinusoidal shape, a plurality of thin fins or fingers extending from the surface thereof, or any other shape or configuration which allows the surface to be easily compressed, the desired intimate contact is achieved. In order to produce a tube member which is capable of providing this intimate contact along its entire length, one profile or layer is formed with the desired surface construction as detailed above and is employed as the first profile or layer forming the multi-component/multi-layer tube member of the present invention. With this profile or layer as the first component of the multi-component/multi-layer tube member, the inside diameter of the tube member is constructed with a particular configuration which is capable of providing compression when applied to the surface of another component.

In FIGS. 7 and 8, one example of a profile or layer constructed for providing the desired intimate contact with the outer surface of a pipe is shown. In this embodiment, profile or layer 30 incorporates a plurality of upstanding fins, flanges, or fingers extending from one surface thereof. By employing the profile or layer 30 as the first layer of the multi-layer product tube member, a construction is achieved which provides a tight fit around any pipe or cylindrical configuration about which the tube member of the present invention is to be employed. Furthermore, by constructing the fins, flanges, or fingers with any desired size or shape, any surface configuration can be easily accommodated.

As a result, the intimate contacting engagement of the inside surface of one tube member with the outside surface of another tube member is easily achieved, with the inside surface of the outer tube being capable of fully and completely contacting and engaging the outer surface of the inner tube member. In this way, the desired secure, nested, fully contacted interengaged relationship being sought is realized. As a result, the prior art difficulties and drawbacks are eliminated and consumer difficulties are fully and completely resolved.

As fully detailed in U.S. Pat. No. 6,537,405, elongated, hollow, tube members can be formed in any desired diameter or configuration by employing a plurality of rotating mandrels. In addition, by employing the teaching of the present invention, in combination with the teaching found in U.S. Pat. No. 6,537,405, an elongated, hollow, multi-component/multi-layer tube member 21 is formed in any desired overall dimension or configuration. By incorporating the teaching found in the present invention, a plurality of profiles or layers are delivered to two or more rotating mandrels for constructing a multi-component/multi-layer tube member having any desired diameter, size, or shape. As a result, the unique features of the present invention as detailed above may be implemented using a multi-mandrel formation system.

In this regard, in addition to the plurality of mandrel configurations and constructions detailed in the foregoing patent, additional configurations not contemplated by or taught in this patent can also be employed. In this regard, a plurality of rotating mandrels may be constructed for independent rotational movement relative to each other, while also mounting the mandrels on a single support plate with the support plate being rotationally moved independently of the mandrels. In this way, further alternate configurations of tube members can be achieved.

In addition, each rotating mandrel may be constructed for being independently movable or movable in combination with each other mandrel. In this way, greatest configurations and diameters can be quickly and easily accommodated and achieved in a single processing equipment. Furthermore, it has also been found that rotating mandrels are not required at each position, and stationary idlers or rotating idlers can also be incorporated into the forming equipment to reduce power consumption as well as equipment complexity.

Finally, in a still further alternate embodiment, expanding drums can be employed for achieving an elongated, hollow, multi-component/multi-layer tube member incorporating a diameter which varies along its length. In this regard, a rotating mandrel is employed which is capable of being increased in diameter along its length. As a result, a generally conically shaped tube member is produced. In this way, production equipment having a wide variety of alternate segments with diverse shapes can be protected with peripherally surrounding tube members manufactured in accordance with the present invention without requiring expensive customized manufacturing operations.

As is apparent from the foregoing detailed disclosure, the present invention attains a unique multi-component/multi-layer tube member, as well as a unique manufacturing process and production equipment which virtually overcomes all of the prior art difficulties and drawbacks. By employing the present invention, industrial applications and needs which have gone unsatisfied are now effectively and efficiently resolved with the products desired. However, although certain examples have been provided as a disclosure of the present invention, it is understood that these examples are merely to teach the overall invention and are not intended as a limitation of the present invention to the particular embodiments disclosed. It is evident that numerous other examples and industries are capable of enjoying the benefits of the present invention and all of these additional embodiments are intended to be encompassed within the scope of the present invention.

It will thus be seen that the objects set forth above, as well as those made apparent from the preceding description, are efficiently attained and, since certain changes may be made in carrying out the above process as well as in the article set forth without departing from the scope of the invention, it is intended that all matter contained in the above description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

Having described our invention, what we claim as new and desire to secure by Letters Patent is:

1. A hollow, elongated, substantially cylindrically shaped, multi-component and/or multi-layer product comprising:
A. a first layer or profile of material
a) having an elongated length and a desired cross-sectional shape, and
b) formed in spiral convolutions in side to side relationship, with each adjacent side surface being integrally bonded to each other, and
B. a second layer or profile of material
a) having an elongated length and a desired cross-sectional shape, and
b) formed about the first layer/profile of material in spiral convolutions with each adjacent side surface of each convolution being integrally bonded to each other, and each bottom surface of the second layer/profile adjacent to the top surface of the first layer/profile being integrally bonded to each other;
whereby a multi-component and/or multi-layer product is provided with each of the individual layers/components being integrally bonded to each other to form a substantially unitary elongated product.

2. The multi-component/multi-layer product defined in claim 1, wherein said product further comprises a third layer or profile formed about the second layer/profile in spiral convolutions, with said third profile/layer being integrally bonded to itself as well as to the second profile/layer.

3. The multi-component/multi-layer product defined in claim 2, wherein said product further comprises additional layers or profiles formed in spiral convolutions about the existing profiles/layers with each additional layers/profiles being integrally bonded to itself as well as to the profile/layer about which the additional profile/layer peripherally surrounds.

4. The multi-component/multi-layer product defined in claim 1, wherein the each of the profiles/layers are further defined as comprising one selected from the group consisting of foamed materials and non-foamed materials.

5. The multi-component/multi-layer product defined in claim 4, wherein the foamed materials comprise one or more selected from the group consisting of polypropylene, polyethylene, cross linking polyethylene, cross-linking poly-propylene, polystyrene, polyurethane, melamine, polyethylene terephthalate (PET), acrylonitrile butadiene styrene (ABS), and ethylene vinyl acetate (EVA), polyolefins, polybutylenes polybutanes, thermoplastic elastomers, thermoplastic polyesters, thermoplastic polyurethanes, ethylene acrylic copolymers, ethylene methyl acrylate copolymers, ethylene butyl acrylate copolymers, and ionomers.

6. The multi-component/multi-layer product defined in claim 4, wherein the non-foamed materials comprise one or more selected from the group consisting of aluminum cladding, woven glass, woven fiber, woven cloth, blown fiberglass cloth, Mylar, rubber, neoprene rubber, and paper.

7. The multi-component/multi-layer product defined in claim 1, wherein said product further comprises an outer jacket or cladding layer integrally formed thereon as the final profile/layer for imparting particularly desired physical and/or structural characteristics for protecting the outer surface of the multi-component/multi-layer product.

8. The multi-component/multi-layer product defined in claim 1, wherein each of the profiles/layers comprise a cross-sectional shape selected from the group consisting of rectangles, squares, parallelograms, polygons, ellipses, circles, ovals, and combinations thereof.

9. The multi-component/multi-layer product defined in claim 1, wherein each of the profiles/layers are integrally bonded to each other by employing one selected from the group consisting of hot air welding, hot wire welding, adhesive bonding, sonic welding, laser welding, mechanical agents, chemical agents, and other known methods of joining materials.

10. The multi-component/multi-layer product defined in claim 1, wherein each of the profiles/layers are further defined as comprising a thickness ranging between about 0.0005 inches and 15 inches.

11. A method for continuously manufacturing elongated, hollow, multi-component and/or multi-layer products comprising the steps of:
A. advancing a first elongated, longitudinally extending, substantially continuous length of material having a desired cross-sectional shape as a first layer or profile onto a rotating mandrel of a forming machine;
B. controllably winding the first elongated, longitudinally extending first profile/layer directly on the rotating mandrel of the forming machine in a manner to cause opposed sides of the first profile/layer to be positioned in juxtaposed, side to side, adjacent relationship when wound on the rotating mandrel;
C. continuously bonding the juxtaposed, adjacent side surfaces of the first profile/layer to each other as the first profile/layer is wound on the rotating mandrel;
D. advancing a second elongated, longitudinally extending length of material having a desired cross-sectional shape as a second profile/layer onto the surface of the first profile/layer formed on the mandrel;
E. continuously winding the second elongated, longitudinally extending, second profile/layer onto the first profile/layer in a manner to cause opposed side edges of the second profile/layer to be positioned in juxtaposed, side to side, adjacent relationship when wound on said first profile/layer;
F. continuously bonding the juxtaposed, adjacent side surfaces of the second profile/layer to each other as a second profile/layer is wound about the first profile/layer;
G. continuously bonding the lower surface of the second profile/layer to the top surface of the first profile/layer as the second profile/layer is wound about the first profile/layer;
H. continuing the forming process by repeating steps A-G until the desired length is achieved for the elongated multi-component/multi-layer product.

12. The manufacturing method defined in claim 11, wherein said method further comprises:
I. advancing a third elongated, longitudinally extending, substantially continuous length of material having a desired cross-sectional shape as a third layer or profile onto the surface of the second profile/layer;
J. continuously winding the third elongated, longitudinally extending profile/layer onto the second profile/layer in a manner to cause opposed side edges of the third profile/layer to be positioned in juxtaposed, side to side, adjacent relationship when wound on the third profile/layer; and
K. continuously bonding the juxtaposed, adjacent side surfaces of the third profile/layer to each other as the third profile/layer is wound about the second profile/layer while also continuously bonding the lower surface of the third profile/layer to the top surface of the second profile/layer as the third profile/layer is wound about the second profile/layer.

13. The manufacturing method defined in claim 12, wherein said method further comprises the advancing and bonding interengagement of additional profiles/layers onto the outer surface of previously formed profiles/layers for achieving a multi-component/multi-layer product having any desired number of profiles/layers integrally bonded to each other.

14. The manufacturing method defined in claim 11, wherein each of the profiles/layers are further defined as comprising one selected from the group consisting of foamed materials and non-foamed materials.

15. The manufacturing method defined in claim 14, wherein the foamed materials comprise one or more selected from the group consisting of polypropylene, polyethylene, cross linking polyethylene, cross-linking polypropylene, polystyrene, polyurethane, melamine, polyethylene terephthalate (PET), acrylonitrile butadiene styrene (ABS), and ethylene vinyl acetate (EVA), polyolefins, polybutylenes polybutanes, thermoplastic elastomers, thermoplastic polyesters, thermoplastic polyurethanes, ethylene acrylic copolymers, ethylene methyl acrylate copolymers, ethylene butyl acrylate copolymers, and ionomers.

16. The manufacturing method defined in claim 14, wherein the non-foamed materials comprise one or more selected from the group consisting of aluminum cladding, woven glass, woven fiber, woven cloth, blown fiberglass cloth, polyester films, polyethylene films, polypropylene films, nylon films, silica films, co-extruded films, Mylar, rubber, neoprene rubber, paper, all water and water vapor transmission blocking media, material, and coatings.

17. The manufacturing method defined in claim 11, wherein each of the profiles/layers comprise a cross-sectional shape selected from the group consisting of rectangles, squares, parallelograms, polygons, ellipses, circles, ovals, and combinations thereof.

18. The manufacturing method defined in claim 11, wherein each of the profiles/layers are integrally bonded to each other by employing one selected from the group consisting of hot air welding, hot wire welding, adhesive bonding, sonic welding, laser welding, mechanical agents, chemical agents, and other known methods of joining materials.

19. The manufacturing method defined in claim 11, wherein at least two cooperating rotating mandrels are employed for producing large diameter multi-component, multi-layer products.
